(19) United States
(12) Patent Application Publication
(10) Pub. No.: US 2020/0317342 A1
(43) Pub. Date: Oct. 8, 2020

(54) DISTRIBUTED CABIN NETWORK ARCHITECTURE

(71) Applicant: ASTRONICS CONNECTIVITY SYSTEMS & CERTIFICATION CORP., Waukegan, IL (US)

(72) Inventors: Joseph Palovick, Moorestown, NJ (US); Eric Tater, Carlsbad, CA (US)

(73) Assignee: ASTRONICS CONNECTIVITY SYSTEMS & CERTIFICATION CORP., Waukegan, IL (US)

(21) Appl. No.: 16/832,556

(22) Filed: Mar. 27, 2020

Related U.S. Application Data
(60) Provisional application No. 62/824,893, filed on Mar. 27, 2019.

(51) Int. Cl. B64D 11/00; H04L 29/08; H04L 12/10

(52) U.S. Cl. CPC B64D 11/0015; H04L 12/10; H04L 67/12

(57) ABSTRACT

A system and method for a cabin network system for an onboard entertainment system of an aircraft cabin, the system including at least one node having an internal CPU, wireless antenna, Ethernet switch and file storage. An A I/O and a content loader are preferably additionally connected with respect to the at least one node.

### CROSS-REFERENCE TO RELATED APPLICATION

This application claims the benefit of U.S. Provisional Patent Application Ser. No. 62/824,893, filed on 27 Mar. 2019. The co-pending Provisional patent application is hereby incorporated by reference herein in its entirety and is made a part hereof, including but not limited to those portions which specifically appear hereinafter.

### FIELD OF THE INVENTION

This invention relates generally to a distributed wireless network for use in an aircraft cabin.

### BACKGROUND OF THE INVENTION

Most commercial airlines provide onboard entertainment and data systems including audio, video, and wireless internet access to their passengers. Such onboard entertainment systems are capable of distributing movies, television, internet access and/or music throughout an aircraft cabin for use on seatback monitors, seat installed audio jacks, and/or passengers' personal electronic devices.

Existing aircraft cabin network architecture is modular but centralized and includes a head end server serviced by content from, for example, a standalone content loader. The SUMMIT™ system by Astronics is one such head end server that provides content to a plurality of enterprise grade access points (“AP”) that are generally distributed downstream of the head end server throughout the cabin.

The APs are reliant on the computing power of the server and scalability is difficult. In addition, the server and the content loader represent single points of failure that can disable or slow the entire system. In addition, pushing data to individual APs from a head end server results in slow downs and choke points in part because traditional systems typically use a daisy-chained series of APs.

Other downsides to existing systems include cooling challenges and rack space availability for the servers. In addition, the computing power of the server may be underutilized depending on the scale of the application. On the contrary, the server may be overutilized for high volume/density scale applications. In addition, the server I/O is limited in existing systems.

Existing systems work with a variety of distributed onboard terminals. Portable entertainment systems are commercially available, including the SIERRA™ system by Astronics, that enable an airline or aircraft owner to quickly and easily retrofit an aircraft to include such onboard entertainment systems.

### SUMMARY OF THE INVENTION

The present invention provides a system and method for incorporating distributed computing into an aircraft cabin to eliminate single points of failure and to provide a scalable solution for many aircraft types and needs.

The present invention combines a CPU, a wi-fi antenna, Ethernet switching and file storage each into a single node that may be scalable as necessary and serviced by a standalone content loader and an A I/O. A related method includes providing one, two, three or more nodes throughout the aircraft cabin, each node having an internal CPU, wireless antenna, Ethernet switch and file storage. Connecting a content loader with respect to the at least one node provides content to the at least one node. Content is thus distributed throughout the aircraft cabin using the one or more nodes.

Other objects and advantages will be apparent to those skilled in the art from the following detailed description taken in conjunction with the claims and drawings.

### BRIEF DESCRIPTION OF THE DRAWINGS

FIG. 1 shows a schematic of a cabin network architecture connected within an aircraft according to the prior art;

FIG. 2 shows a schematic of a cabin network architecture connected within an aircraft according to one embodiment;

FIG. 3 shows a schematic of a cabin network architecture according to one embodiment; and

FIG. 4 shows a block diagram of a node according to one embodiment.

### DETAILED DESCRIPTION OF THE INVENTION

The present invention provides a system and method for providing an aircraft cabin with a distributed network architecture. For ease of explanation, the following description will generally refer generally to wired, Wi-Fi™ and/or Bluetooth wireless onboard entertainment and information systems that are provided to individual seat back or personal device entertainment stations, called passenger service units (PSU). It should be understood that the system and method of this invention may be used with any type of wired or wireless local area network systems.

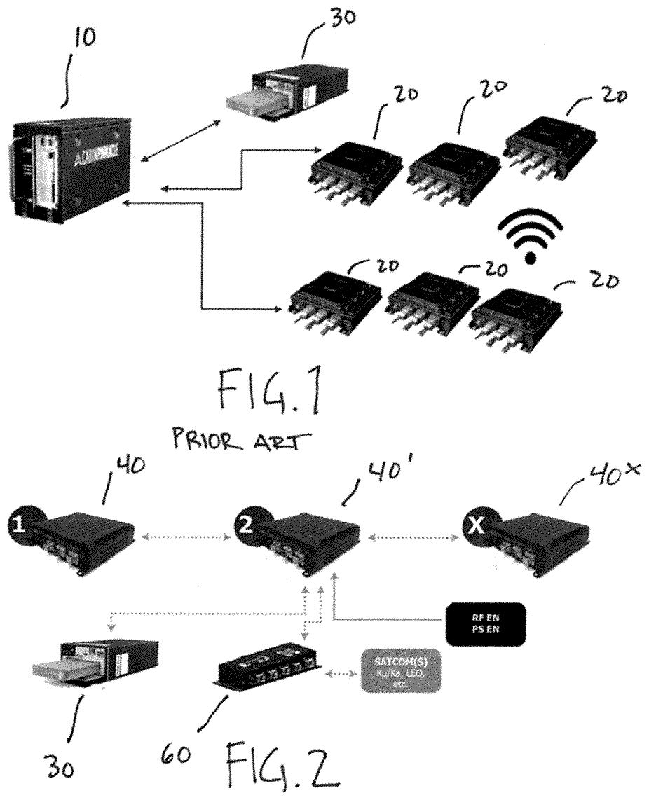

FIG. 1 shows a schematic of one embodiment of a cabin network architecture as incorporated into an aircraft according to the prior art. In this arrangement a central head end server 10 is connected with respect to a plurality of access points 20 (AP). Although centralized, the design is modular and each box has a specialized function. Each AP 20 serves a portion of the cabin and communicates with the head end server 20. A stand alone content loader 30 is connected, either permanently or periodically, with the head end server 20 to provide necessary content to the head end server 10. As a result of this arrangement, both the head end server 10 and the content loader 20 represent a single point of failure for the cabin network architecture in the event of hardware or software interruptions or damage.

The cabin network architecture as described below is preferably used in connection with an onboard entertainment and information system of an aircraft cabin. Such onboard entertainment systems stream movies, television, music, flight information and other content to passengers.

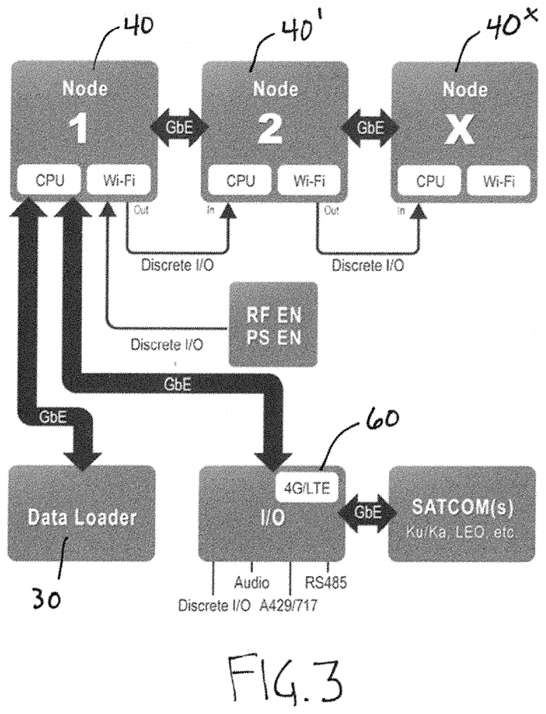

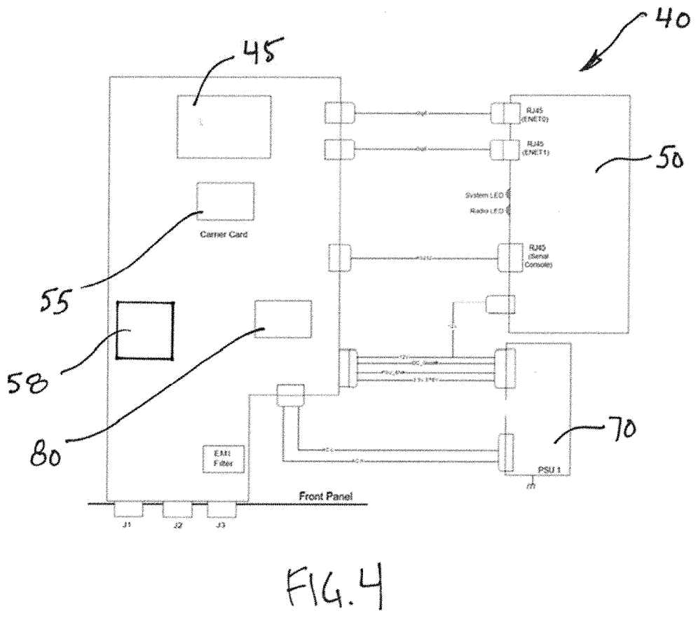

FIGS. 2 and 3 show a cabin network system for an onboard entertainment system of an aircraft includes at least one node 40, and optimally two nodes 40, 40′ or three nodes 40, 40′, 40″ and up to X nodes 40^{X}. According to one preferred embodiment, up to 16 nodes may be installed per aircraft. Each node 40 preferably includes an internal CPU 45, wireless antenna 50 also referred to as an access point or AP, Ethernet switch 55 and file storage 58. As described, one or more nodes 40, specifically the SMARTWAP™ system manufactured by Astronics, are distributed, in scalable fashion, throughout an aircraft cabin.

A content loader 30 is preferably additionally connected, either permanently or periodically, with respect to the at least one node 40 for providing content to the at least one node 40. The cabin network system preferably further includes an A I/O 60 connected with respect to the at least one node 40. In one embodiment in a system having two or more nodes 40, 40′, 40″, 40^{X}, the content loader 30 may be connected with respect to only a single node, such as first node 40.

FIG. 3 shows a detailed distributed architecture block diagram wherein X nodes 40 . . . 40^{X} are connected with respect to the A I/O 60 and a content loader 30 is connected to only a first node 40. Each successive node 40′, 40X is preferably daisy chained in communication with an adjacent node according to this embodiment. In this manner the subject system is redundant, scalable, upgradeable, modular and utilizes a distributed architecture such that a single failure does not affect system performance; the system can run in a degraded mode with only one node 40 operating; and the “heavy-lifting” of the system is accomplished in several spots, thereby potentially eliminating choke points and bottleneck inherent in conventional systems.

FIG. 4 shows a block diagram of a node 40 according to one preferred embodiment. As shown in this embodiment, the CPU 45 comprises an Intel processor and Linux operating system. The file storage 58 may comprise one or more SSD hard drives. Applications may be added to each node 40 via Containers or VMs.

According to one embodiment, a customized version of Linux operating system may run on each node 40 as a privileged domain. As such, access is provided to the hardware using a split-driver model via API. A guest agent may emulate hardware specific items including BIOS, network and disk access.

As further shown in FIG. 4, each node 40 preferably further includes at least one and preferably two power supplies that are capable of operation with a nominal 115 VAC WF aircraft power bus. In an embodiment having two power supplies, each preferably operates with using nominal aircraft power. A first, or primary, power supply 70 is preferably the main power supply for the node 40. A second, or secondary, power supply 80 is preferably used to power the Ethernet switch 55 and associated circuitry to allow for a bypass function in the case of a failure of the primary power supply.

According to one preferred embodiment, each node 40 includes two output signals and six input discrete signals. In this embodiment, four of the six input discrete signals may be configured to address strapping pins to allow for up to 15 separate addressing configurations of the node.

The A I/O 60, or aircraft discrete input/output device, provides an interface between the aircraft bus and each node 40. In conventional systems, the head end server connects to all aircraft bus systems such as GPS, aircraft telemetry, discretes (e.g., weight on wheels, door open/close), flight phase, PA pause and others. Here instead, the A I/O 60 accomplishes these connections (e.g., ARINC 429/717, audio, discrete I/O, and ARINC 485) and takes such data stores it, packetizes it and provides it to the nodes 40. In this manner, the aircraft data is collected, aggregated and processed on the A/O 60 and consumed by the at least one node 40. The A I/O 60 may include multiple inputs and multiple outputs. The A I/O 60 as described preferably enables connection between the respective nodes 40, 40′, 40″ and Satcom(s) such as Ku/Ka, LEO, etc.

In addition, the A I/O 60 may include a cellular modem, local storage capability, and additional external Ethernet ports to support other Ethernet devices. The A I/O 60 includes a dedicated CPU that may operate on an Intel processor and a Linux operating system including integrated storage.

Physically, the node(s) 40 as described are preferably constructed within a unitized housing having connector interfaces compliant with standard aircraft bus connectors. One and preferably two cooling fans are preferably positioned external to the housing for cooling heat sinks on both sides of the housing from ambient air.

A related method for operating a cabin network system for an onboard entertainment system of an aircraft cabin comprises providing one or more nodes throughout the aircraft cabin, each node having an internal CPU, wireless antenna, Ethernet switch and file storage; and connecting an A I/O with respect to the at least one node and a content loader providing content to the at least one node; and distributing content throughout the aircraft cabin using the at least one nodes.

In operation, each of the nodes 40, 40′, 40″, 40^{X} preferably include redundant systems and content. Such an arrangement permits each node 40 . . . 40^{X} to operate alone or in series or parallel to serve as both clients and as servers and avoid single points of failure that are inherent in existing systems.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A cabin network system for an onboard entertainment system of an aircraft cabin, the system comprising:
at least one node having an internal CPU, wireless antenna, Ethernet switch and file storage; and
an A I/O connected with respect to the at least one node.

2. The cabin network system of claim 1 further comprising:
a content loader connected with respect to the at least one node for providing content to the at least one node.

3. The cabin network system of claim 1 comprising two or more nodes wherein the A I/O is connected with respect to only a first node.

4. The cabin network system of claim 3 wherein each of the two or more nodes include redundant systems and content.

5. The cabin network system of claim 1 comprising three or more nodes.

6. The at least one node of claim 1 further comprising a first power supply and a second power supply.

7. The at least one node of claim 1 wherein the at least one node comprises two output signals and six input discrete signals.

8. The at least one node of claim 1 comprising a unitized housing having external connector interfaces compliant with standard aircraft bus connectors.

9. The at least one node of claim 1 further comprising two external cooling fans.

10. A method for operating a cabin network system for an onboard entertainment system of an aircraft cabin, the method comprising:
providing two or more nodes throughout the aircraft cabin, each node having an internal CPU, wireless antenna, Ethernet switch and file storage;
connecting an A I/O with respect to the at least two nodes; and
distributing content throughout the aircraft cabin using the two or more nodes.

11. The method of claim 10 further comprising:
connecting a content loader with respect to the at least two nodes for providing content to the at least two nodes.

12. The method of claim 10 further comprising connecting the A I/O with respect to only a first node of the two or more nodes.

13. The method of claim 10 further comprising:
providing a first power supply for each node of the least two nodes and a second power supply for each node providing a bypass of the Ethernet switch.
